(19) United States
(12) Patent Application Publication
(10) Pub. No.: US 2026/0014832 A1
(43) Pub. Date: Jan. 15, 2026

(54) ACTIVE GRILLE SHUTTER WITH MULTI-AXIS PIVOTS

(71) Applicant: Ford Global Technologies, LLC, Dearborn, MI (US)

(72) Inventors: Kyle Begle, Walled Lake, MI (US); Aaron Peter Klop, Bloomfield Hills, MI (US); Craig M. Watson, Commerce Township, MI (US); Patrick J. Reed, Livonia, MI (US)

(21) Appl. No.: 18/769,795

(22) Filed: Jul. 11, 2024

(51) Int. Cl. F16K 31/52; B60H 1/00; B60K 11/08

(52) U.S. Cl. CPC B60H 1/00671; B60K 11/085

(57) ABSTRACT

A vehicle flow control system, including: a shutter of an active grille shutter assembly, the shutter rotatable about a shutter axis; an actuator shaft assembly rotatable about an actuator shaft assembly axis; and a link rotatably coupling the shutter to the actuator shaft assembly, the link rotatable about at least two link axes relative to the shutter axis and relative to the actuator shaft assembly axis.

### TECHNICAL FIELD

This disclosure relates generally to an active grille shutter assembly and, more particularly, to such an assembly having joint pivotable about more than one axis.

### BACKGROUND

Vehicle flow control system can incorporate active grille shutter assemblies having shutters that are actuated to control flow to various areas of a vehicle, such as radiators, condensers, and other systems. The shutters can be opened when flow to a particular area is needed. The shutters can be closed to reduce drag. The shutters may need to be aligned with the curvature of the vehicle.

### SUMMARY

In some aspects, the techniques described herein relate to a vehicle flow control system, including: a shutter of an active grille shutter assembly, the shutter rotatable about a shutter axis; an actuator shaft assembly rotatable about an actuator shaft assembly axis; and a link rotatably coupling the shutter to the actuator shaft assembly, the link rotatable about at least two link axes relative to the shutter axis and relative to the actuator shaft assembly axis.

In some aspects, the techniques described herein relate to a vehicle flow control system, wherein the shutter axis and the actuator shaft assembly axis are transverse to each other.

In some aspects, the techniques described herein relate to a vehicle flow control system, wherein a ball-and-socket joint rotatably couples the link to one of the shutter or the actuator shaft assembly.

In some aspects, the techniques described herein relate to a vehicle flow control system, wherein the ball-and-socket joint is a first ball-and-socket joint that rotatable couples the link to the shutter, and further including a second ball-and-socket joint that rotatably couples the link to the actuator shaft assembly.

In some aspects, the techniques described herein relate to a vehicle flow control system, wherein the first ball-and-socket joint is at a first end of the link, wherein the second ball-and-socket joint is at an opposite, end of the link.

In some aspects, the techniques described herein relate to a vehicle flow control system, wherein the shutter is a first shutter and the link is a first link, and further including a second link rotatably coupling a second shutter to the actuator shaft assembly.

In some aspects, the techniques described herein relate to a vehicle flow control system, wherein the first shutter and the first link are on a driver side of a vehicle, wherein the second shutter and the second link are on a passenger side of the vehicle.

In some aspects, the techniques described herein relate to a vehicle flow control system, further including an actuator that drives the actuator shaft assembly to rotate about the actuator shaft assembly axis, the actuator disposed between the first link and the second link, and disposed between the first shutter and the second shutter.

In some aspects, the techniques described herein relate to a vehicle flow control system, wherein actuator shaft assembly includes a driver side shaft that is rotatably coupled to the first link, and a passenger side shaft that is coupled to the second link.

In some aspects, the techniques described herein relate to a vehicle flow control system, wherein the shutter axis is a first shutter axis of the first shutter, and further including a second shutter axis of the second shutter, the first shutter axis transverse to the second shutter axis.

In some aspects, the techniques described herein relate to a vehicle flow control system, further including a housing, the first shutter and the second shutter each pivotably coupled to the housing.

In some aspects, the techniques described herein relate to a vehicle flow control system, wherein the at least two link axes includes a first link axis and a second link axis that are transverse to each other.

In some aspects, the techniques described herein relate to a vehicle flow control system, wherein the first link axis is parallel to the shutter axis.

In some aspects, the techniques described herein relate to a vehicle flow control system, wherein the first link axis is parallel to the actuator shaft assembly axis.

In some aspects, the techniques described herein relate to a vehicle flow control system, wherein the actuator shaft assembly includes a pivot arm that projects radially from the actuator shaft assembly axis and is rotatably coupled to the link.

In some aspects, the techniques described herein relate to a vehicle flow control system, including; first and second shutters, the first shutter configured to rotate about a first shutter axis, the second shutter configured to rotate about a second shutter axis, the first shutter axis and the second shutter axis transverse to each other; an actuator shaft assembly rotatably about an actuator shaft axis that is transverse to both the first shutter axis and the second shutter axis; first and second links, the first link coupling the first shutter to the actuator shaft assembly, the second link coupling the second shutter to the actuator shaft assembly; and an actuator that drives the actuator shaft assembly to rotate about the actuator shaft assembly to drive the first shutter to rotate about the first shutter axis through the first link, and to drive the second shutter to rotate about the second axis through the second link.

In some aspects, the techniques described herein relate to a vehicle flow control system, wherein the actuator shaft assembly includes a driver side portion on a driver side of the actuator, and a passenger side portion on a passenger side of the actuator.

In some aspects, the techniques described herein relate to a vehicle flow control system, wherein the first shutter and the first link are on a driver side of a vehicle, wherein the second shutter and the second link are on a passenger side of the vehicle.

In some aspects, the techniques described herein relate to a vehicle flow control system, further including a first ball-and-socket joint that couples a first end of the first link to the first shutter, and a second ball-and-socket joint that couples an opposite, second end of the first link to the actuator shaft assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a vehicle having a flow control system according to an exemplary aspect of the present disclosure with shutters of the flow control system in a first position.

FIG. 2 illustrates the perspective view of FIG. 1 with the shutters in a second position that permits more flow that the shutters in the first position.

FIG. 3 shows a rear view of the flow control system of FIG. 1.

FIG. 4 shows a close-up view of a shutter on a driver side of the vehicle.

FIG. 5 shows the close-up view of FIG. 4 with the shutter in a position permitting more flow that the position of FIG. 4.

FIG. 6 shows a top view of shutters and an actuation shaft assembly of the flow control system of FIG. 3.

### DETAILED DESCRIPTION

An active grille shutter assembly of a vehicle flow control system can include shutters that can be moved between positions that permit more flow through the active grille shutter assembly and positions that permit less flow. This disclosure is directed toward vehicle flow control systems associated with active grille shutter assemblies having shutters pivotable about axes that are transverse to one another. Orienting the shutters in this way may be needed to, for example, align the shutters with an exterior of the vehicle. The example systems of this disclosure can utilize multi-axis joints to facilitate driving such shutters with a single actuator.

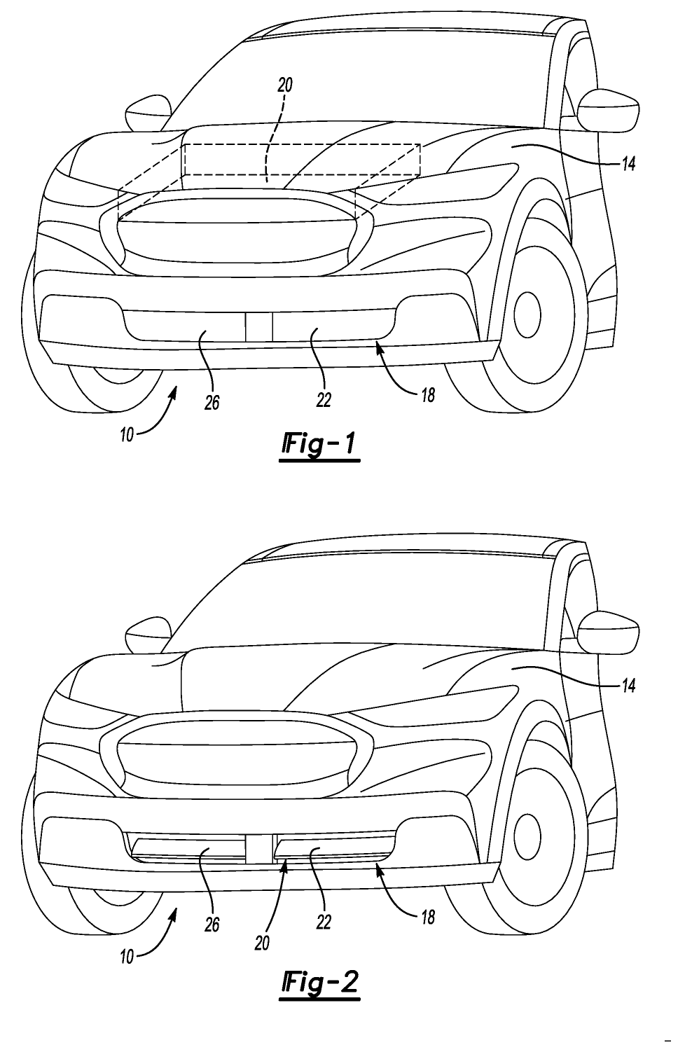

Referring to FIGS. 1 and 2, in an exemplary embodiment, a front 10 of a vehicle 14 includes a flow control system having an active grille shutter assembly 18 that is utilized to control a movement of a flow F of air from outside the vehicle 14 to a compartment 20 of the vehicle 14.

In some examples, the compartment 20 is an engine compartment. The compartment 20 could also be a frunk. Although disclosed in connection with the vehicle 14 and the compartment 20, the active grille shutter assembly 18 could be utilized to control flow to other areas of the vehicle 14, such as an opening to a passenger compartment of the vehicle 14 or to another area of the vehicle 14.

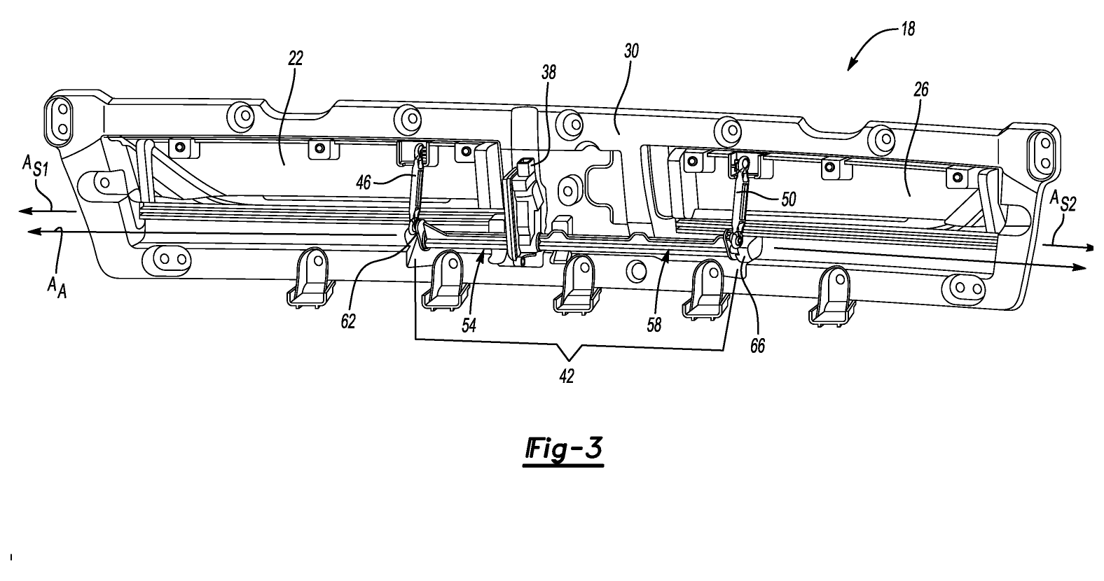

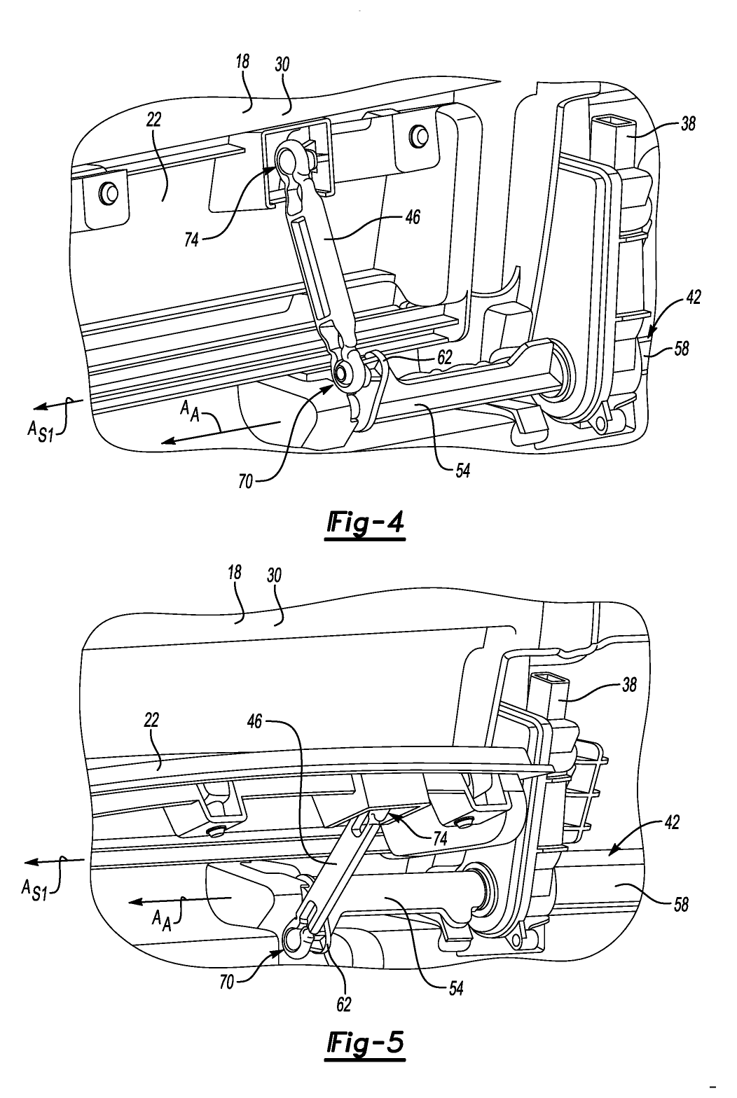

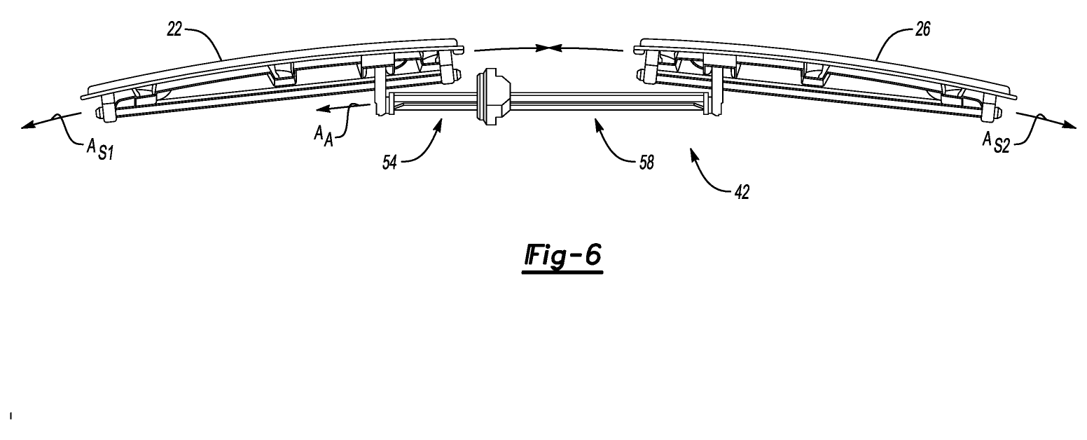

With reference now to FIGS. 3–6 and continuing reference to FIGS. 1 and 2, the active grille shutter assembly 18, in the exemplary embodiment, includes a first shutter 22 and a second shutter 26 that are each pivotably secured within a housing 30. The first shutter 22 is configured to pivot back-and-forth about a first shutter axis A_{S1} between positions that permit more flow to the compartment 20 and positions that permit less flow to the compartment 20. The second shutter 26 is configured to pivot back-and forth about a second shutter axis A_{S2} between positions that permit more flow to the compartment 20 and positions that permit less flow to the compartment 20. When positioned as shown in FIG. 2, the first shutter 22 and the second shutter 26 permit more flow to the compartment than when positioned as shown in FIG. 1. In FIG. 1, the first shutter 22 and the second shutter 26 can be considered to be in a closed position.

To rotate the first shutter 22 and the second shutter 26, the active grille shutter assembly 18 includes an actuator 38, an actuator shaft assembly 42, a first link 46, and a second link 50. The actuator 38 can be a motor that, as required, is activated to rotatably drive rotation of the actuator shaft assembly 42 about an actuator shaft assembly axis A_{A.}

The actuator shaft assembly 42 includes a driver side portion 54 and a passenger side portion 58. The driver side portion 54 of the actuator shaft assembly 42 is on a driver side of the actuator 38. A passenger side portion 58 of the actuator shaft assembly 42 projects from the actuator 38 to a passenger side. The actuator 38 is disposed at a centerline of the vehicle 14 in this example. The actuator 38 is disposed between the first link 46 and the second link 50, and between the first shutter 22 and the second shutter 26.

The driver side portion 54 includes a first pivot arm 62 extending radially from the actuator shaft assembly axis A_{A} to connect to the first link 46. The passenger side portion 58 includes a second pivot arm 66 extending radially from the actuator shaft assembly axis A_{A} to connect to the second link 50. Rotating the actuator shaft assembly 42 about the actuator shaft assembly axis A_{A} rotates the first shutter 22 through the first link 46 and rotates the second shutter 26 through the second link 50.

The first link 46 is pivotably coupled to the first pivot arm 62 at a first end of the first link 46. An opposite, second end of the first link 46 is pivotably coupled to the first shutter 22.

The actuator shaft assembly axis A_{A} is transverse to the first shutter axis A_{S1}. In this example, to accommodate the axes being transverse to each other, the first end of the first link 46 is coupled to the first pivot arm 62 through a ball-and-socket joint 70, which permits the first link 46 to pivot relative to the first pivot arm 62 about more than one axis. A ball-and-socket joint can be considered a heim joint.

In this example, the first link 46 pivots about the actuator shaft assembly axis A_{A}, or an axis parallel to the actuator shaft assembly axis A_{A}, as the first pivot arm 62 rotates. The first link 46 can additionally pivot about another axis outward away from a centerline of the vehicle 14. In this example, the first link 46 provides the socket portion of the ball-and-socket joint 70, and the first pivot arm 62 includes the ball portion. As can be appreciated, the ball-and-socket joint 70 could be reversed such that the first link 46 provides the ball portion and the first pivot arm 62 includes the socket portion.

The second end of the first link 46 is pivotably coupled to the first shutter 22 through another ball-and-socket joint 74. The first link 46 pivots the first shutter 22 through the ball-and-socket joint 74 about the first shutter axis A_{S1.} when driven by the actuator shaft assembly 42.

The ball-and-socket joint 74 allows the first link 46 to pivot about more than one axis relative to the first shutter 22. The ball-and-socket joint 74 allows, in this example, the first link 46 to pivot and flex slightly outward away from a centerline of the vehicle 14 as the first pivot arm 62 rotates about the actuator shaft assembly axis A_{A}. The first link 46 is thus pivotably about the about the first shutter axis A_{S1} (or an axis parallel to the first shutter axis A_{S1}) along with another axis transverse to the first shutter axis A_{S1}. As can be appreciated, the ball-and-socket joint 74 could be reversed such that the first link 46 provides the ball portion and the first shutter includes the socket portion.

While the ball-and-socket joints 70 and 74 are used in the exemplary embodiment to provide the ability to pivot about more than one axis, other joints could be used in other examples. For example, the first link 46 could include a pin could be received within an oversized aperture of the first shutter 22 to permit relative multi-axial movement between the first link 46 and the first shutter 22 as the first link 46 drives the first shutter 22 to rotate about the first shutter axis A_{S1}.

Again, the example first link 46 is rotatable about at least two axes relative to the first shutter axis A_{S1} and relative to the actuator shaft axis A_{A}. The pivoting of the actuator shaft assembly 42 about the actuator shaft axis A_{A} is a pivoting relative to the housing 30 and, more particularly, a fixed pivot relative to the housing 30. The pivoting of the first shutter 22 about the first shutter axis A_{S1} relative to the housing 30 is also considered a fixed pivot.

The pivot provided by the ball-and-socket joint 70 pivotably coupling the first link 46 to the first pivot arm 62 of the actuator shaft assembly 42 can be considered a moving pivot because the joint moves when the actuator shaft assembly 42 is driven to rotate about the actuator shaft axis A_{A}. The ball-and-socket joint 74 pivotably coupling the first shutter 22 to the first link 46 is also a moving pivot.

Together, the first link 46, the first shutter 22, the housing 30, and the driver side portion 54 of the actuator shaft assembly 42 provide a four-bar linkage that rotates the first shutter 22 about the first shutter axis A_{S1.} The second link 50, the second pivot arm 66 extending from the passenger side portion 58, the housing 30, and the second shutter 26 establish another four-bar linkage responsible for driving rotation of the second shutter 26 about the second shutter axis A_{S2.} The second link 50, the second pivot arm 66 extending from the passenger side portion 58, the housing 30, and the second shutter 26 operate similarly to the first link 46, the first shutter 22, the housing 30 and the driver side portion 54.

Features of this disclosure include a system that moves shutters of an active grille assembly with a single actuator although the shutters rotate about axes that are transverse to one another. The actuator can rotate a single shaft to drive rotation of the shutters. As the shutters are rotating about axes that are transverse to each other, joints accommodating movement about more than one axes are utilized.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A vehicle flow control system, comprising:
a shutter of an active grille shutter assembly, the shutter rotatable about a shutter axis;
an actuator shaft assembly rotatable about an actuator shaft assembly axis; and
a link rotatably coupling the shutter to the actuator shaft assembly, the link rotatable about at least two link axes relative to the shutter axis and relative to the actuator shaft assembly axis.

2. The vehicle flow control system of claim 1, wherein the shutter axis and the actuator shaft assembly axis are transverse to each other.

3. The vehicle flow control system of claim 1, wherein a ball-and-socket joint rotatably couples the link to one of the shutter or the actuator shaft assembly.

4. The vehicle flow control system of claim 3, wherein the ball-and-socket joint is a first ball-and-socket joint that rotatable couples the link to the shutter, and further comprising a second ball-and-socket joint that rotatably couples the link to the actuator shaft assembly.

5. The vehicle flow control system of claim 4, wherein the first ball-and-socket joint is at a first end of the link, wherein the second ball-and-socket joint is at an opposite, end of the link.

6. The vehicle flow control system of claim 1, wherein the shutter is a first shutter and the link is a first link, and further comprising a second link rotatably coupling a second shutter to the actuator shaft assembly.

7. The vehicle flow control system of claim 6, wherein the first shutter and the first link are on a driver side of a vehicle, wherein the second shutter and the second link are on a passenger side of the vehicle.

8. The vehicle flow control system of claim 6, further comprising an actuator that drives the actuator shaft assembly to rotate about the actuator shaft assembly axis, the actuator disposed between the first link and the second link, and disposed between the first shutter and the second shutter.

9. The vehicle flow control system of claim 8, wherein actuator shaft assembly includes a driver side shaft that is rotatably coupled to the first link, and a passenger side shaft that is coupled to the second link.

10. The vehicle flow control system of claim 6, wherein the shutter axis is a first shutter axis of the first shutter, and further comprising a second shutter axis of the second shutter, the first shutter axis transverse to the second shutter axis.

11. The vehicle flow control system of claim 6, further comprising a housing, the first shutter and the second shutter each pivotably coupled to the housing.

12. The vehicle flow control system of claim 1, wherein the at least two link axes includes a first link axis and a second link axis that are transverse to each other.

13. The vehicle flow control system of claim 12, wherein the first link axis is parallel to the shutter axis.

14. The vehicle flow control system of claim 12, wherein the first link axis is parallel to the actuator shaft assembly axis.

15. The vehicle flow control system of claim 1, wherein the actuator shaft assembly includes a pivot arm that projects radially from the actuator shaft assembly axis and is rotatably coupled to the link.

16. A vehicle flow control system, comprising;
first and second shutters, the first shutter configured to rotate about a first shutter axis, the second shutter configured to rotate about a second shutter axis, the first shutter axis and the second shutter axis transverse to each other;
an actuator shaft assembly rotatably about an actuator shaft axis that is transverse to both the first shutter axis and the second shutter axis;
first and second links, the first link coupling the first shutter to the actuator shaft assembly, the second link coupling the second shutter to the actuator shaft assembly; and
an actuator that drives the actuator shaft assembly to rotate about the actuator shaft assembly to drive the first shutter to rotate about the first shutter axis through the first link, and to drive the second shutter to rotate about the second axis through the second link.

17. The vehicle flow control system of claim 16, wherein the actuator shaft assembly includes a driver side portion on a driver side of the actuator, and a passenger side portion on a passenger side of the actuator.

18. The vehicle flow control system of claim 16, wherein the first shutter and the first link are on a driver side of a vehicle, wherein the second shutter and the second link are on a passenger side of the vehicle.

19. The vehicle flow control system of claim 16, further comprising a first ball-and-socket joint that couples a first end of the first link to the first shutter, and a second ball-and-socket joint that couples an opposite, second end of the first link to the actuator shaft assembly.
